(19) United States
(12) Patent Application Publication
(10) Pub. No.: US 2018/0294072 A1
(43) Pub. Date: Oct. 11, 2018

(54) CABLE FOR LAMP STRING

(71) Applicant: Te-Hui Lin, Zhubei City (TW)

(72) Inventor: Te-Hui Lin, Zhubei City (TW)

(21) Appl. No.: 15/480,377

(22) Filed: Apr. 6, 2017

(51) Int. Cl. H01B 7/04; F21S 4/10; H01B 7/08

(52) U.S. Cl. CPC H01B 7/04; F21Y 2115/10; H01B 7/0823; F21S 4/10

(57) ABSTRACT

A cable for a lamp string is provided herein. The cable may include a number of wires arranged in parallel and aligned in a planar manner, or in a V- or W-like manner. One or more of the wires may be flexible wires or tensile wires. The flexible wire has a core made of a bendy material capable of retaining a new shape, and the tensile wire has a core made of a nonconductive and tensile material.

### BACKGROUND OF THE INVENTION

### (a) Technical Field of the Invention

The present invention generally relates to lamp strings and, more particularly, to a cable for lamp strings.

### (b) Description of the Prior Art

As a lamp string is longer, its weight is also heavier, often causing troubles such as broken wires or disruption of electricity. On the other hand, in order to arrange a lamp string into a planar or three-dimensional shape, a frame is required and the lamp string has to be tied, bound, adhered, or fastened to the frame. For a different shape, the lamp string has to be completely rearranged, which is quite inconvenient and inflexible.

### SUMMARY OF THE INVENTION

To obviate the conventional lamp strings' lack of tensile strength and failure to mold into shape, the present invention provides a novel cable where wires of enhanced tensile strength or flexibility are integrated with wires of insulating sleeves into a new type of cable. For this type of new cables, its application and usage are more flexible and convenient.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings, identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1A is a perspective diagram of a lamp string cable according to a first embodiment of the present invention.

FIG. 1B is a perspective diagram showing a lamp string cable according to a second embodiment of the present invention.

FIG. 1C is a perspective diagram showing a lamp string cable according to a third embodiment of the present invention.

FIG. 1D is a perspective diagram showing a lamp string cable according to a fourth embodiment of the present invention.

FIG. 1E is a perspective diagram showing a lamp string cable according to a fifth embodiment of the present invention.

FIG. 1F is a perspective diagram showing a lamp string cable according to a sixth embodiment of the present invention.

FIG. 2A is a perspective break-down diagram showing a light emitting diode (LED) lamp configured on the lamp string cable of FIG. 1B.

FIG. 2B is another perspective break-down diagram showing a LED lamp configured on the lamp string cable of FIG. 1B.

FIG. 2C is another perspective break-down diagram showing a LED lamp housed in a cap configured on the lamp string cable of FIG. 1B.

FIG. 3 is another perspective diagram showing a LED lamp on the lamp string cable of FIG. 1B.

FIG. 4 is a schematic sectional diagram a LED lamp on the lamp string cable of FIG. 1C.

FIG. 5 is a perspective break-down diagram showing a LED lamp configured on the lamp string cable of FIG. 1D.

FIG. 6 is a perspective break-down diagram showing a LED lamp configured on the lamp string cable of FIG. 1E.

FIG. 7 is a schematic perspective diagram showing a lower member for configuring a LED lamp on the lamp string cable of the present invention.

FIG. 8 is a perspective diagram showing a lamp string using a cable of the present invention arranged on a frame.

### DETAILED DESCRIPTION OF THE PREFERRED EMBODIMENTS

The following descriptions are exemplary embodiments only and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

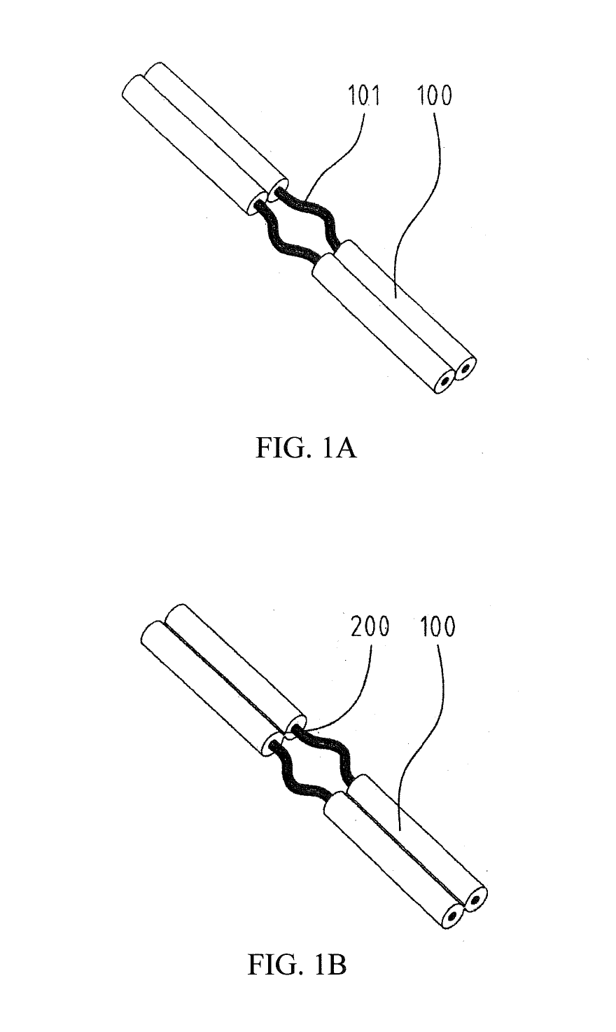

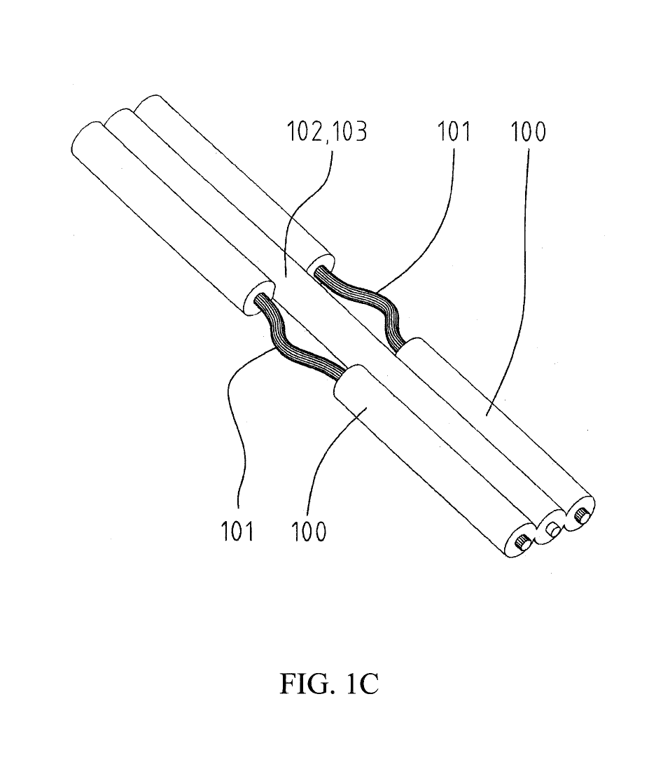

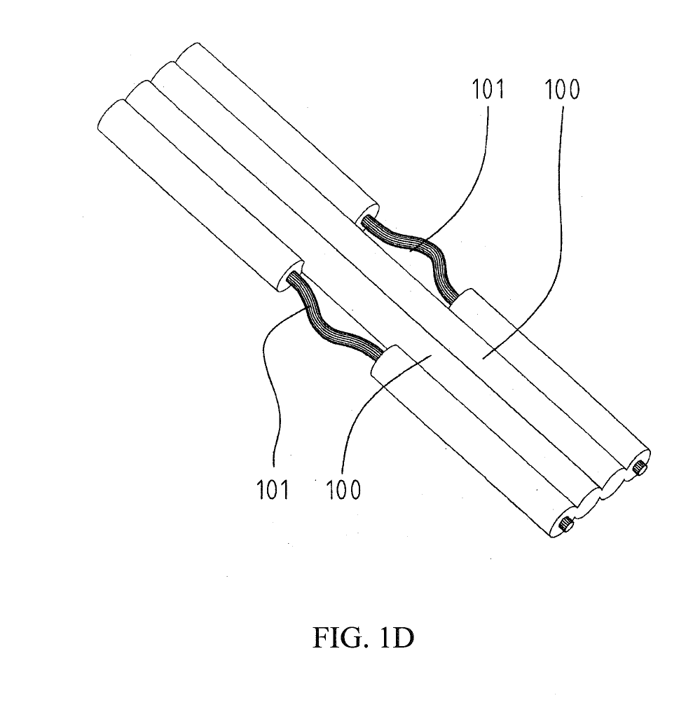

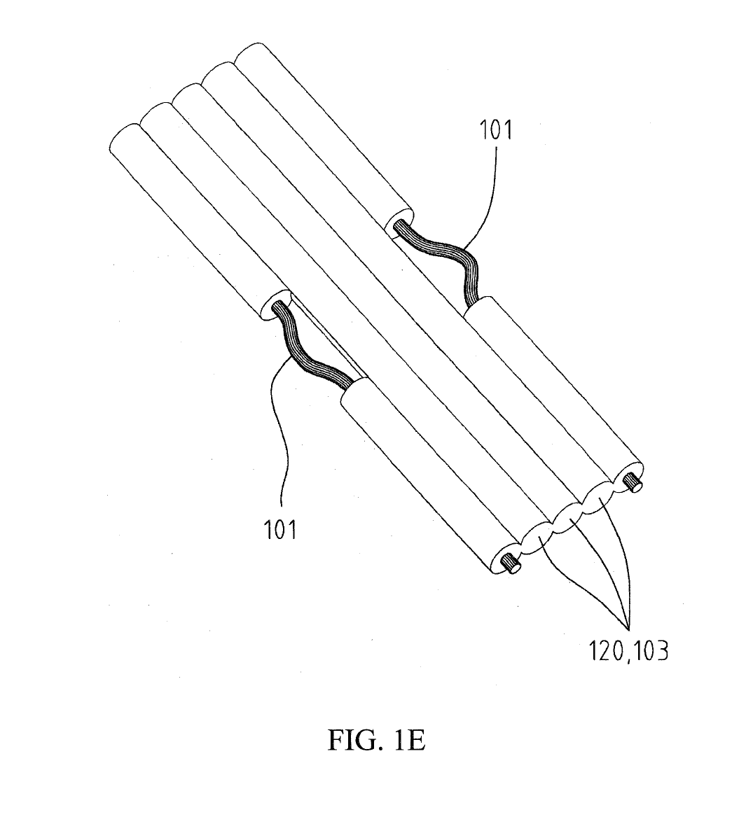

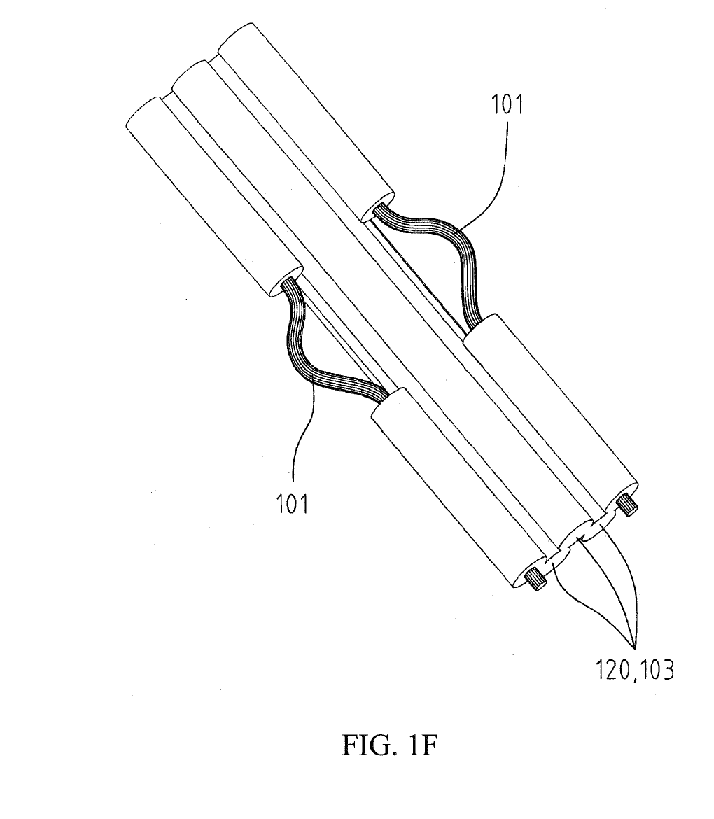

A cable for a lamp string according to the present invention may involve two, three, four, five, or more wires 100, arranged in parallel and aligned in a planar manner, or in a V- or W-like manner (as shown in FIG. 1F). For a two-wire cable, the two wires 100 may be integrally formed so that they adjoin each other as shown in FIG. 1A, or a flat plastic connection piece 200 in between is integrally formed together as shown in FIG. 1B. The connection piece 200 reinforces the tensile strength of the cable, and allows nails to run through to fix the cable without damaging the wires 100. For a three-wire cable, as shown in FIG. 1C, a flexible wire 102 or a tensile wire 103 is sandwiched between two wires 100. For the flexible wire 102, its core 101 is made of a material that is bendy but capable of retaining a new shape. In some embodiment, the core 101 of a flexible wire 102 is conductive. For the tensile wire 103, its core 101 is made of a nonconductive and tensile material. For a four-wire cable, four wires 100 are arranged in parallel in a planar manner, as shown in FIG. 1D. The four wires may be separated into two independent groups, one having three wires and one having one wire. The three-wire group is for connecting an independent power source, and the one wire is a flexible wire having a core made of a bendy material capable of retaining a new shape. For a five-wire cable, as shown in FIGS. 1E and 1F, one or more of the inner wires are flexible wires 102, or tensile wires 103, or a combination thereof As such, the five-wire cable may also function similar to a three-wire or four-wire cable.

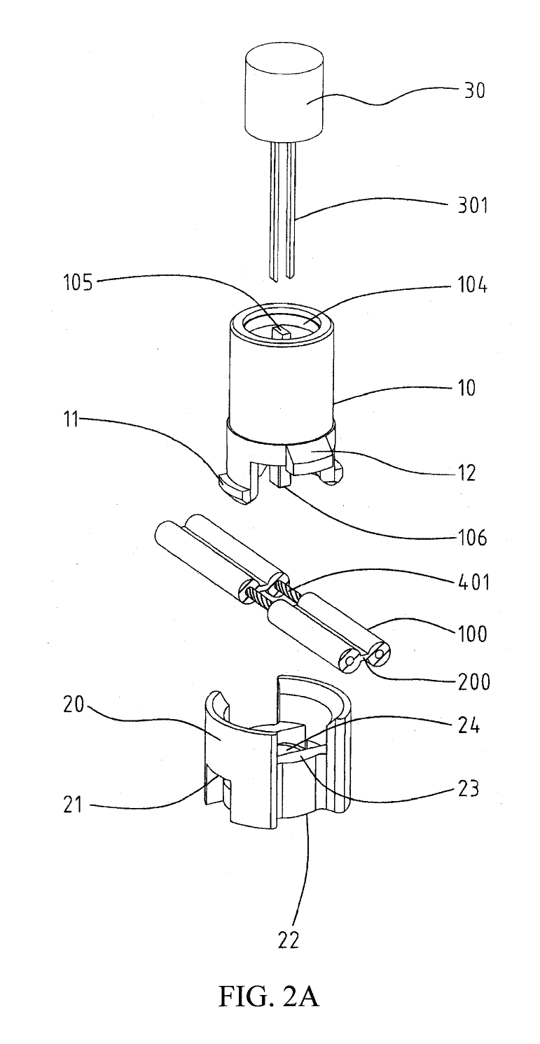

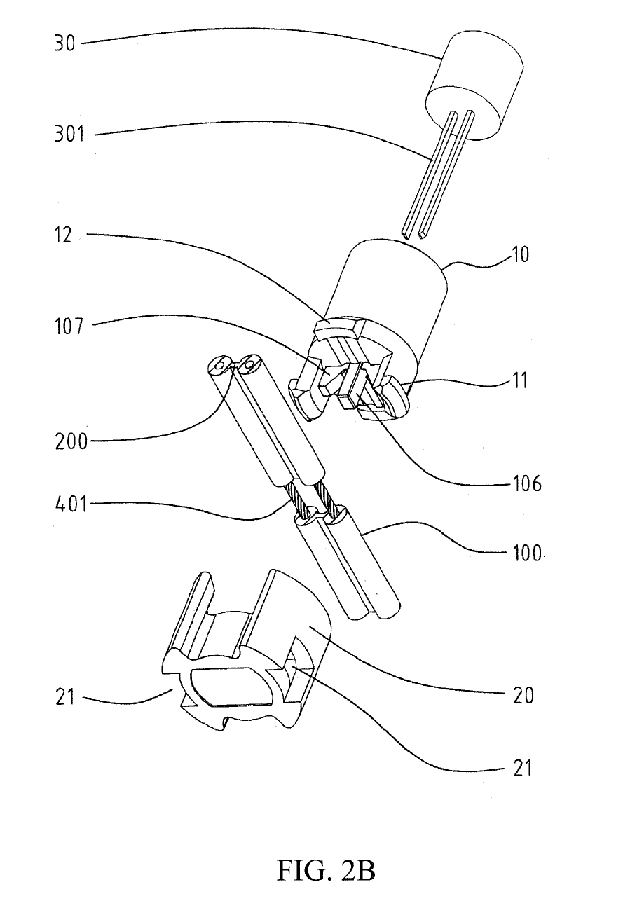

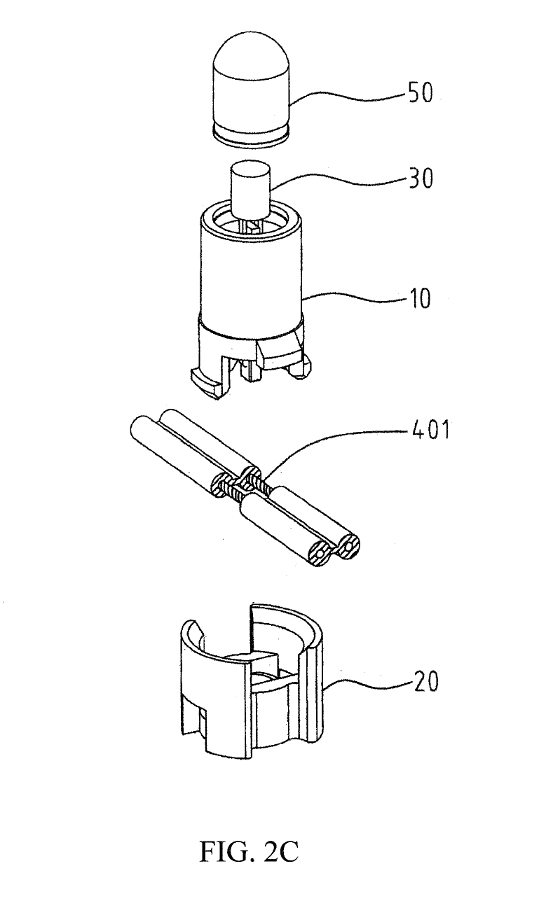

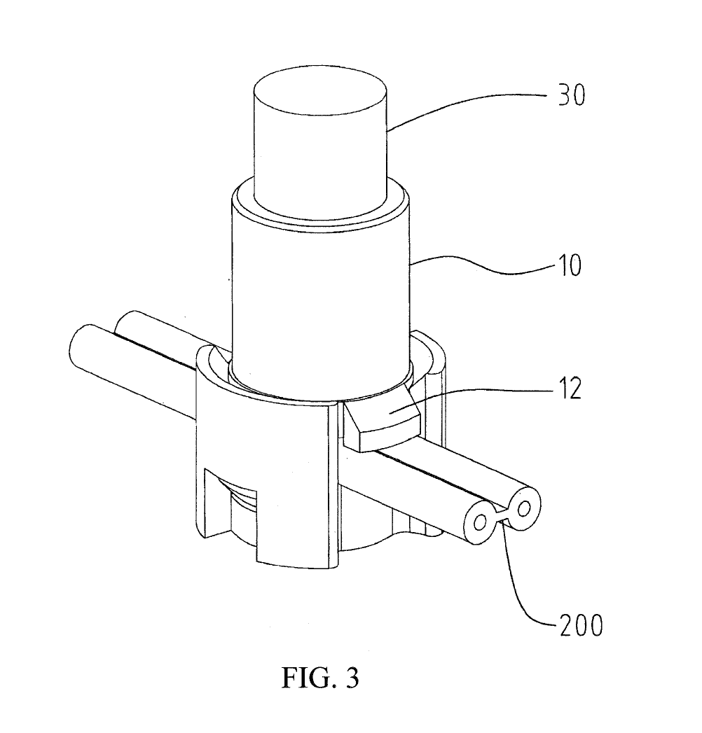

As shown in FIGS. 2 and 3, a lamp string involving a two-wire cable of the present invention includes at least an upper member 10, a lower member 20, and a light emitting diode (LED) 30. Atop section of the upper member 10 includes an accommodation space 104 and an upward protruding support piece 105 in the middle of the accommodation space 104. The LED 30 is mounted on the support piece 105. A bottom section of the upper member 10 includes two oppositely positioned downward protruding legs 11 having J-like shapes and two oppositely positioned laterally protruding blocks 12, where the legs 11 and the blocks 12 are alternately arranged. The upper member 10 is plugged into an indentation on a top side of the lower member 20. The lower member 20 has two troughs 22 along the axial direction and on the circumference of the lower member 20 for receiving the blocks 12. On the other hand, the legs 11 are received by two sockets 21, each formed between the circumference of the lower member 20 and a ring wall 24 inside the lower member 20.

A bottom section of the upper member 10 has a partition piece 106 aligned with the support piece 105, and two oppositely positioned suppressing blocks 107 at the lateral sides of the partition piece 106, respectively. Each suppressing block 107 has a slant face tilted toward the partition piece 106. Correspondingly, the partition piece 106 has two faces towards the slant faces of the suppressing blocks 107. The two faces may be vertical or slant. When the LED 30 is mounted on the support piece 105, its two legs 301 run through the upper member 10 and extend beside the partition piece 106. When the upper and lower members 10 and 20 are joined with the core exposed sections 401 of a two-wire cable in between, the wires 100 are held down by the blocks 12 of the upper member 10 whereas two chord blocks 23 in the indentation on the top side of the lower member 20 force the wires 100 upward. Each exposed core is then forced by the slant face of a suppressing block to tightly contact with a leg 301 of the LED 30 between the partition piece 106 and the suppressing block 107. As shown in FIG. 2C, the LED 30 may be housed in a cap 50 for protection.

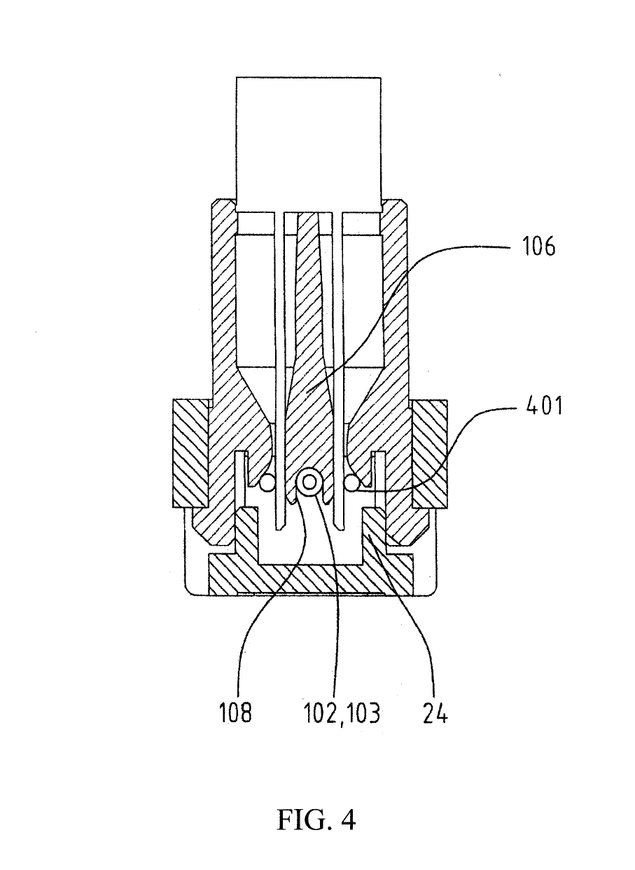

As shown in FIG. 4, a lamp string may involve a three-wire cable of the present invention. For the three-wire cable 100, a flexible wire 102 or a tensile wire 103 is sandwiched between two wires 100. For the flexible wire 102, its core 101 is made of a material that is bendy but capable of retaining a new shape. For the tensile wire 103, its core 101 is made of a nonconductive and tensile material. This embodiment is similar to the previous one except that the partition piece 106 provides a slot 108 that is U-shaped on a bottom end so as to position the flexible wire 102 or the tensile wire 103 in the middle of the three-wire cable.

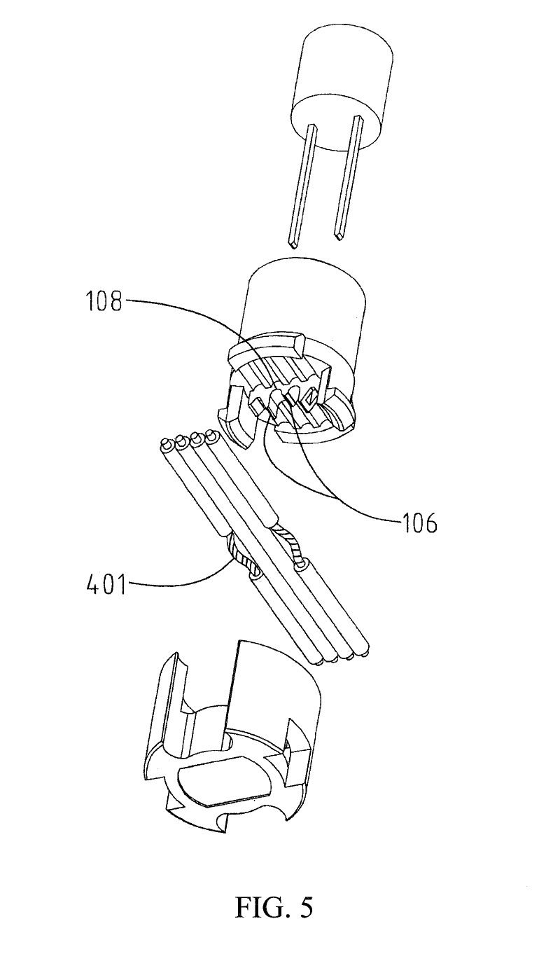

As shown in FIG. 5, a lamp string may involve a four-wire cable of the present invention. This embodiment is similar to the previous ones except that the partition piece 106 provides a slot 108 that is W-shaped so as to receive the middle two wires of the four-wire cable.

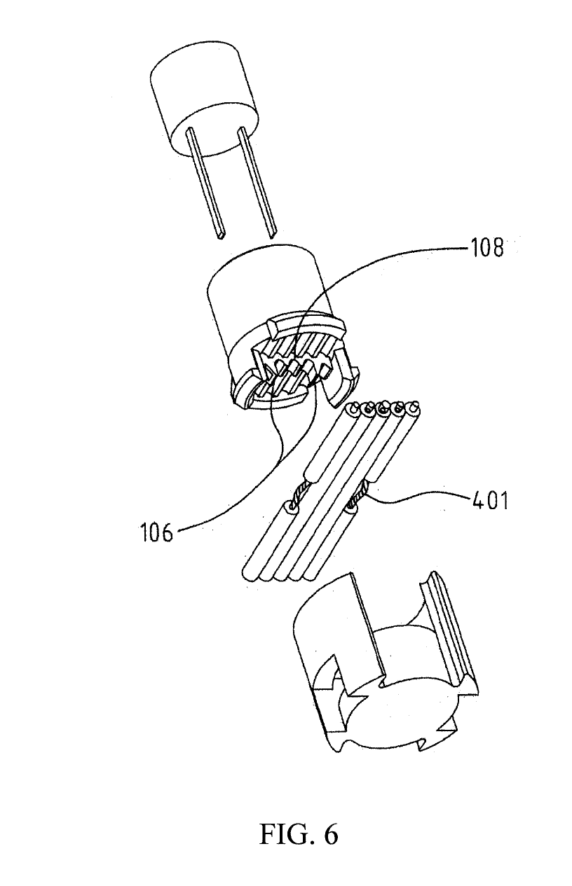

As shown in FIG. 6, a lamp string may involve a five-wire cable of the present invention. This embodiment is similar to the previous ones except that the partition piece 106 provides a slot 108 that is saw-tooth-shaped so as to receive the middle three wires of the five-wire cable.

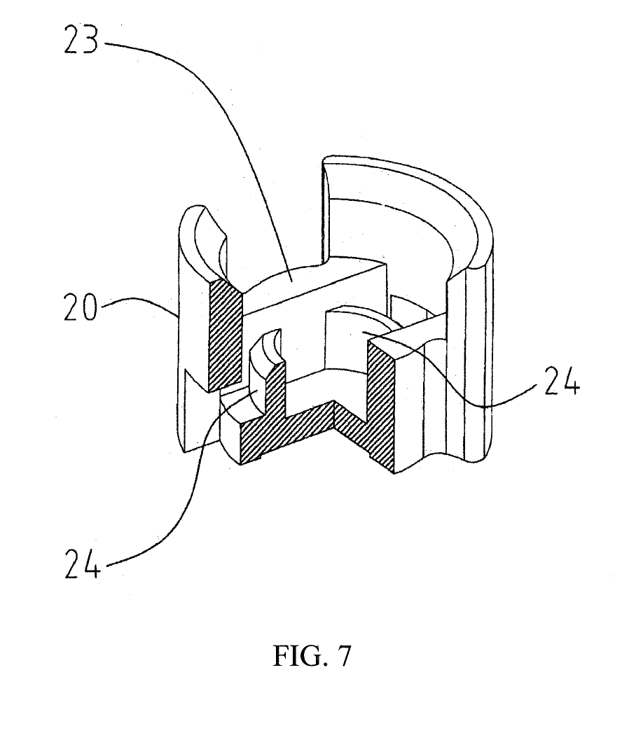

FIG. 7 shows the details inside a lower member 20, especially about the configuration of the chord blocks 23 and the ring wall 24.

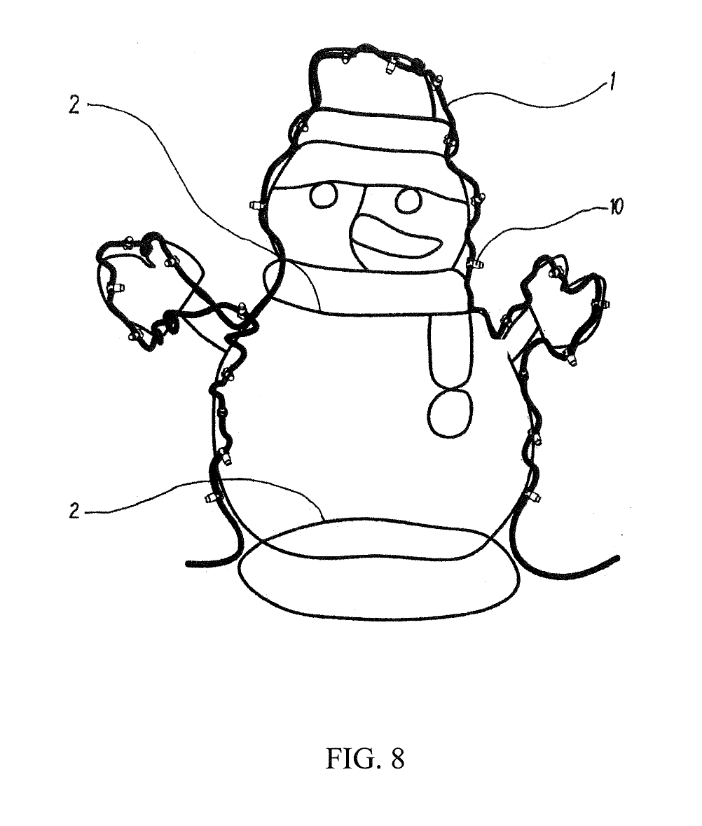

FIG. 8 provides an application scenario of the present invention where a cable of the present invention is arranged along a contour of a frame. For the present invention, even without the frame, the cable with a flexible wire 102 configured can still be arranged into a similar or different shape.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

1. A cable for a lamp string, comprising at least four wires arranged in a planar manner, wherein the two outermost wires have neighboring sections of their cores exposed, each for contacting a leg of light emitting diode; and the other wires have a core made of a nonconductive and tensile material.

2-8. (canceled)

5. A cable for a lamp string, comprising five wires arranged in a W-like manner, wherein the two outermost wires have neighboring sections of their cores exposed, each for contacting a leg of light emitting diode; and the other wires have a core made of a nonconductive and tensile material.

6-8 (canceled)
